(19) United States
(12) Patent Application Publication
(10) Pub. No.: US 2026/0342601 A1
(43) Pub. Date: Oct. 29, 2026

(54) SYSTEM AND METHOD FOR QUANTUM-RESISTANT CRYPTOGRAPHIC REFLECTION ARCHITECTURE FOR DISTRIBUTED-LEDGER TRANSACTION DATA

(71) Applicant: Michael A. Fesi, II, Houma, LA (US)

(72) Inventor: Michael A. Fesi, II, Houma, LA (US)

(21) Appl. No.: 19/661,073

(22) Filed: Apr. 28, 2026

Related U.S. Application Data
(60) Provisional application No. 63/795,932, filed on Apr. 28, 2025.

(51) Int. Cl. H04L 9/00; H04L 9/08

(52) U.S. Cl. CPC H04L 9/50; H04L 9/0852

(57) ABSTRACT

A computer-implemented system for quantum-resistant cryptographic protection of distributed-ledger transaction data. Upon close of a transaction block, a reflection generation engine generates N cryptographic reflections, each comprising a multi-component commitment including content, state, temporal, chain anchor, sibling reflection, and algorithm fingerprint components. Reflections are constructed using a heterogeneous set of cryptographic primitives such that no two reflections share identical primitives, and reflections do not contain recoverable transaction data. Each reflection is distributed to a corresponding vault implemented as a cloud storage service, a custodial storage arrangement, a sovereign data facility, or a smart contract repository, each vault operating under a distinct custody and jurisdictional regime. An anomaly-aware multi-factor authentication gate validates retrieval requests. A three-tier verification module supports existence proof, integrity attestation, and forensic recovery modes.

### CROSS-REFERENCE TO RELATED APPLICATIONS

The present application claims priority to U.S. Provisional Application No. 63/795,932 filed Apr. 28, 2025, titled “SYSTEM AND METHOD FOR RISK-BASED COMPRESSION, IMMUTABLE ARCHIVING, AND FORENSIC VERIFICATION OF BLOCKCHAIN TRANSACTION DATA,” which is hereby incorporated by reference.

### TECHNICAL FIELD

The embodiments generally relate to systems and methods for quantum-resistant cryptographic protection of distributed-ledger transaction data, including systems for generating heterogeneous cryptographic reflections of canonical transaction blocks, distributing reflections across cryptographically and jurisdictionally separated vault infrastructures, and authenticating retrieval through an anomaly-aware multi-factor gate, such that the integrity of distributed-ledger transaction records is preserved against adversarial threats including harvest-now-decrypt-later attacks leveraging cryptographically relevant quantum computers.

### BACKGROUND

Distributed-ledger systems including public, permissioned, and consortium blockchains record transaction data using cryptographic primitives that are computationally secure against classical computational adversaries but become computationally vulnerable to adversaries equipped with cryptographically relevant quantum computers. Elliptic-curve digital signature schemes, including the Elliptic Curve Digital Signature Algorithm widely deployed in distributed-ledger systems, are computationally vulnerable to attack by Shor's algorithm executed on a sufficiently capable quantum computer. The data recorded on distributed ledgers is, by design, public and permanent. Adversaries may capture distributed-ledger transaction data at the present time and store the captured data for future cryptanalytic processing once a cryptographically relevant quantum computer becomes available, a class of attack referred to as harvest-now-decrypt-later.

Conventional approaches to post-quantum protection of distributed-ledger transaction data include cryptographic primitive substitution, cryptographic agility frameworks, and off-chain encryption of transaction data. Cryptographic primitive substitution requires modification of the underlying distributed-ledger consensus mechanism, breaking compatibility with existing nodes and historical transaction data. Cryptographic agility frameworks introduce substantial protocol complexity and do not protect transaction data already recorded under vulnerable schemes. Off-chain encryption of transaction data does not protect the on-chain transaction record itself.

There exists a need for systems and methods that protect the integrity of distributed-ledger transaction data against adversaries equipped with cryptographically relevant quantum computers without requiring modification of the underlying distributed-ledger consensus mechanism, without depending on the computational security of any single post-quantum cryptographic primitive, and while preserving the public verifiability of distributed-ledger transaction data for legitimate audit, regulatory, and forensic purposes.

Standards bodies have begun formalizing responses to the harvest-now-decrypt-later threat. The U.S. National Institute of Standards and Technology published final post-quantum cryptography standards in Federal Information Processing Standards Publications 203, 204, and 205 in August 2024, covering lattice-based key encapsulation (ML-KEM), lattice-based digital signatures (ML-DSA), and hash-based digital signatures (SLH-DSA), and in March 2025 selected a code-based key encapsulation mechanism (HQC) for an additional standardization track. Early experimental results leveraging quantum annealing hardware, including research published in the Chinese Journal of Computers demonstrating factorization of small RSA integers using a D-Wave Advantage quantum annealer, further underscore the need for cryptographic protection of distributed-ledger transaction data that does not rely solely on the computational security of classical cryptographic primitives.

Conventional systems for managing blockchain transaction data often rely on full-node storage or pruning mechanisms to reduce data load. These systems typically retain all transactional records across distributed networks or, alternatively, remove non-essential historical data to preserve storage space. Some implementations use basic compression techniques to minimize the storage footprint of transaction logs or ledger data. However, these methods generally prioritize data efficiency over regulatory or forensic detail, which can limit their usability in high-compliance environments where granular transaction records must remain accessible for audit and investigative purposes.

Standard database archiving solutions operate independently from blockchain systems and are often deployed to shift inactive or aged records to secondary storage environments. These tools use periodic data exports or time-based triggers to archive records, allowing active systems to run more efficiently. While effective in reducing system load, these solutions rarely implement cryptographic security measures or immutable record structures, and they typically lack integration with decentralized ledger technologies. As a result, archived records may remain vulnerable to unauthorized modification, and cross-referencing archived data with live blockchain records can require significant manual effort.

Other approaches leverage off-chain storage networks, such as the InterPlanetary File System, to hold large blockchain-related data files externally while maintaining on-chain references for retrieval. These systems help scale blockchain ecosystems by reducing on-chain storage demands, but they can introduce verification complexity and often lack built-in mechanisms for real-time auditability or transaction risk differentiation. Blockchain explorers and analytics platforms also offer searchable interfaces for transactional data but do not incorporate native compression, audit logging, or risk-aware archiving protocols. Manual audit and compliance approaches, which rely on human-led reviews and periodic snapshots, remain labor-intensive and can struggle to keep pace with the volume and velocity of data generated in real-time tokenized economies.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A computer-implemented system for quantum-resistant cryptographic protection of distributed-ledger transaction data comprises one or more hardware processors and a non-transitory memory storing instructions that, when executed, instantiate a reflection generation engine, a multi-vault distribution layer, an authentication and anomaly monitoring gate, and a three-tier verification module. Upon close of a transaction block on an associated distributed ledger, the reflection generation engine snapshots the closed block and generates a plurality of N cryptographic reflections of the closed block.

Each cryptographic reflection comprises a multi-component commitment to the closed block including a content commitment, a state commitment, a temporal commitment, a chain anchor, a sibling reflection commitment, and a cryptographic algorithm fingerprint. Each reflection further comprises a digital signature binding the commitment components under a private cryptographic key, and a reflection identifier formed from a sequential counter, a timestamp component, and a cryptographically secure pseudorandom component. The cryptographic reflection does not contain a recoverable copy of the transaction data of the closed block.

The plurality of N reflections is generated using a heterogeneous set of cryptographic algorithms, such that no two reflections in the plurality are generated using identical cryptographic primitives. The heterogeneous algorithms are selected from a configurable algorithm registry comprising at least one classical cryptographic suite and a plurality of post-quantum cryptographic suites including hash-based signature schemes, lattice-based signature schemes, and quantum-resistant hash functions.

Each reflection is transmitted to a corresponding vault in a plurality of N vaults. Each vault in the plurality is implemented as one of a cloud storage service operated by a distinct cloud provider, a custodial storage arrangement operated by a distinct regulated custodian, a sovereign data facility operated under a distinct jurisdictional regime, and a smart contract repository deployed on a distinct distributed ledger, such that each vault operates under a custody arrangement and a jurisdictional regime distinct from each other vault.

An authentication and anomaly monitoring gate validates retrieval requests directed to the plurality of vaults using at least two authentication factors and applies anomaly detection logic to retrieval request patterns across the plurality of vaults to detect adversarial harvest patterns.

A three-tier verification module supports three modes of cryptographic verification: an existence proof mode using one reflection, an integrity attestation mode using at least two reflections with cross-validation, and a forensic recovery mode using all N reflections with full cross-validation.

By combining heterogeneous cryptographic reflection generation, multi-vault jurisdictional distribution, anomaly-aware authentication gating, and tiered verification, the system preserves the cryptographic integrity of distributed-ledger transaction data against an adversary equipped with a cryptographically relevant quantum computer without modification of the distributed-ledger consensus mechanism and without dependence on the computational security of any single cryptographic primitive.

The reflection generation engine may incorporate selective compression and risk classification of transaction data within the closed block as a configurable embodiment, such that reflections generated for blocks containing transactions assigned a higher classification tag retain a greater quantity of transaction metadata fields than reflections generated for blocks containing only transactions assigned a lower classification tag.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an operational workflow of the system, showing a block close event on an on-chain canonical block 600 triggering a reflection generation engine 640 to snapshot the closed block and build N cryptographic reflections by way of a multi-component commitment constructor 645, generation of four cryptographic reflections 650a, 650b, 650c, and 650d respectively paired with distinct hash and digital signature primitives, distribution of the reflections to jurisdictionally separated vaults 610, 620, 625, and 630, retrieval gating by an AAS-2FA authentication and anomaly monitoring gate 635, and a three-tier verification module offering an existence proof mode 661 applicable to routine compliance, an integrity attestation mode 662 applicable to incident response, and a forensic recovery mode 663 applicable to a full audit, according to some embodiments.

FIG. 2 illustrates the internal structure of a cryptographic reflection 650 generated from a source block 600, showing a content commitment 651 comprising a Merkle root computed over transaction data and a Merkle proof construction parameter and binding the reflection to the source block, a state commitment 652 comprising a hash of a post-block world state, a temporal commitment 653 comprising a verifiable timestamp at block close, a chain anchor 654 comprising a canonical block hash obtained from the associated distributed ledger, a sibling reflection commitment 655 comprising hashes of all other cryptographic reflections in the set and binding the reflection to its siblings, a cryptographic algorithm fingerprint 656 identifying the hash and signature primitives used, a digital signature 657 binding components 651 through 656 under a private cryptographic key, a reflection identifier 658 formed from a counter, a timestamp, and a pseudorandom component, and a non-recoverable property assertion 659 indicating that the reflection is a commitment to the source block and does not contain a recoverable copy of the transaction data, according to some embodiments.

FIG. 3 illustrates a cryptographic algorithm registry 670 configurable through a policy database 260 and organized into a hash function class 671 comprising SHA-3, BLAKE3, SHA-256 as a classical option, and a post-quantum hash as an extensibility slot, and a digital signature class 672 comprising ML-DSA as a lattice post-quantum option, SLH-DSA as a hash-based post-quantum option, Falcon as a lattice post-quantum option, and ECDSA as a classical option, each class being extensible through registry update, an algorithm assignment module 675 ensuring a distinct hash and signature pair for each reflection, four example reflection pairings (reflection 650a paired with SHA-3 and ECDSA, reflection 650b paired with SHA-3 and ML-DSA, reflection 650c paired with BLAKE3 and SLH-DSA, and reflection 650d paired with BLAKE3 and Falcon) together with a further reflection 650n reserved for future pairings, and a cryptographic agility rotation 680 path triggered by policy update or by revision of applicable standards, such that no two reflections in the set share an identical hash and signature pairing and compromise of a single cryptographic primitive defeats at most one reflection, according to some embodiments.

FIG. 4 illustrates a three-tier verification decision flow, showing a verification request 690 comprising a target block identifier and requestor credentials entering an AAS-2FA authentication and anomaly monitoring gate 635 that applies authentication and generates an anomaly score, a mode selection stage 691 routing the request along a routine path to an existence proof mode 661 retrieving one of N reflections and checking the chain anchor, along an incident path to an integrity attestation mode 662 retrieving two of N reflections and performing cross-validation, or along a forensic path to a forensic recovery mode 663 retrieving all N reflections and performing full validation, a cryptographic validation module 692 verifying hash, signature, sibling commitments, and chain anchor, and outcomes comprising a pass 693 that returns the verification result and logs the event to a compliance database, a fail 694 that identifies the implicated cryptographic primitive and triggers an integrity alert, and a quarantine 695 that flags the affected vault and invokes the cryptographic agility rotation 680, according to some embodiments.

FIG. 5 illustrates a representative computer system 100 suitable for implementing components of the system disclosed herein, the computer system 100 comprising a processor 110, a memory 120 storing application instructions 140 and data storage 150, one or more input/output devices 130, and one or more interfaces 160 including a network interface 165, a user interface 170, and a peripheral device interface 175, the foregoing components being interconnected by a bus 180, and further illustrating the computer system 100 communicating over a network 190 with a user computing device 145, an administrator computing device 185, and a third-party computing device 195, according to some embodiments.

FIG. 6 illustrates a high-level processing pipeline of the system in which an external system providing transaction snapshots and logs, including an AAS-2FA-protected source, supplies input to a data ingestion and classification module 202 that receives the snapshots and logs and classifies the data by risk, a policy and rules engine 203 that applies administrator-defined or AI-derived policies and determines compression thresholds, a compression engine 205 that compresses the data based on the applied policy and prepares a compressed output, an artifact generation module 204 that creates cryptographically sealed artifacts including hashes and signatures, a database engine 211 implementing a black-box repository that stores immutable artifacts and maintains tamper-proof records, a forensic retrieval and verification module 207 that fetches artifacts on request and validates their cryptographic integrity, and a display module 208 that provides a user interface for administrators and auditors and presents compression statistics and retrieval logs to admin and auditor devices, according to some embodiments.

FIG. 7A illustrates an application platform 200 incorporating QR-MCAA modules and engines and the upstream portion of an end-to-end data flow, including a user database 250 that holds users and roles and exchanges user authentication, permissions, and credentials with the application platform 200, the data ingestion and classification module 202 that applies initial risk tagging to received snapshots and logs and outputs snapshot data and risk tags to a transaction snapshot database 255 storing raw transaction snapshots and logs, the policy and rules engine 203 that retrieves compression and risk policies from the transaction snapshot database 255 and decides compression thresholds, a policy and rules database 260 that holds administrator-defined or AI-driven compression policies and exchanges policy lookups and updates with the policy and rules engine 203, an optional artificial-intelligence anomaly detection database 285 that holds model parameters and risk scores used by an artificial-intelligence or machine-learning component if integrated for risk analysis, the compression engine 205 that receives data and policies including a risk level and compresses the snapshots accordingly, a compressed data staging database 265 that holds intermediate compressed blobs prior to artifact generation, and the artifact generation module 204 that cryptographically seals data into immutable artifacts and appends metadata including timestamps and risk identifiers, with off-page connectors A, B, and C continuing the flow into FIG. 7B, according to some embodiments.

FIG. 7B illustrates the downstream portion of the end-to-end data flow continued from FIG. 7A through off-page connectors A, B, and C, including an artifact repository database 270 that stores finalized artifacts as a black-box repository, a forensic and verification database 275 that holds index and validation references for the artifacts and supplies validation retrieval to the forensic retrieval and verification module 207, the forensic retrieval and verification module 207 that fetches and validates artifacts for audits and that uses cryptographic checks performed by an engine 209 when needed, a compliance and audit logs database 280 that records system actions, artifact accesses, and policy changes, an archival and reporting database 290 that stores aggregated metrics including compression and usage statistics and that generates regulatory reports, and a display and reporting interface 208 through which administrators, auditors, and external regulators view real-time statistics, retrieval logs, and compliance reports, the display and reporting interface 208 communicating over a network 190 and exchanging user, administrator, and auditor credentials with the application platform 200 for cross-checking against the user database 250, according to some embodiments.

FIG. 8 illustrates a method performed by the system, the method comprising a receive-and-classify step 410 that receives raw transaction snapshots and logs from an AAS-2FA source, classifies the data by risk into high, medium, and low risk classifications, and optionally creates or updates user and policy information; an apply-policy-and-select-compression-parameters step 415 that retrieves a policy from the policy and rules database 260, optionally fetches risk scores from the artificial-intelligence anomaly detection database 285 if an artificial-intelligence component is used, and determines a compression algorithm based on risk; a compress-data step 420 in which the compression engine 205 applies the chosen method, stores the result in the compressed data staging database 265, and validates compression success or failure; a generate-immutable-artifacts step 425 in which the artifact generation module 204 cryptographically seals the compressed data with a hash and signature, attaches metadata including a timestamp and a risk identifier, and updates the forensic and verification database 275; and a store-artifacts-and-forensic-access step 430 that moves the artifacts to the artifact repository database 270, logs actions in the compliance and audit logs database 280, and permits users including administrators and auditors to retrieve artifacts and generate reports from the archival and reporting database 290, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “MCAA” refers to the Micro-Compression Artifacting Algorithm disclosed in U.S. Provisional Application No. 63/795,932, and the term “QR-MCAA” refers to the Quantum-Resistant Mirror-Cryptographic Artifacting Algorithm that extends MCAA as disclosed in the present application.

The system disclosed herein is designed to counter an adversary model in which an adversary captures distributed-ledger transaction data at a present time and retains the captured data for subsequent cryptanalytic processing using a cryptographically relevant quantum computer that becomes available at a future time. This adversary model, referred to herein as harvest-now-decrypt-later, threatens distributed-ledger transaction data because the data is, by design, public, permanent, and secured by cryptographic primitives that are vulnerable to quantum attack including the Elliptic Curve Digital Signature Algorithm and related elliptic-curve schemes vulnerable to Shor's algorithm.

Cryptographic primitive substitution, in which classical primitives in the underlying distributed-ledger consensus mechanism are replaced with post-quantum primitives, requires modification of the consensus mechanism and breaks compatibility with historical transaction data recorded under the classical primitives. Cryptographic agility frameworks, which allow algorithm substitution within the consensus mechanism, introduce substantial protocol complexity and do not protect data already recorded under vulnerable primitives. Off-chain encryption of transaction data does not protect the on-chain transaction record itself.

The technical problem addressed by the present embodiments is the preservation of the cryptographic integrity of distributed-ledger transaction data against a quantum-capable adversary without modification of the underlying distributed-ledger consensus mechanism, without reliance on the computational security of any single cryptographic primitive, and while preserving public verifiability for legitimate audit, regulatory, and forensic purposes.

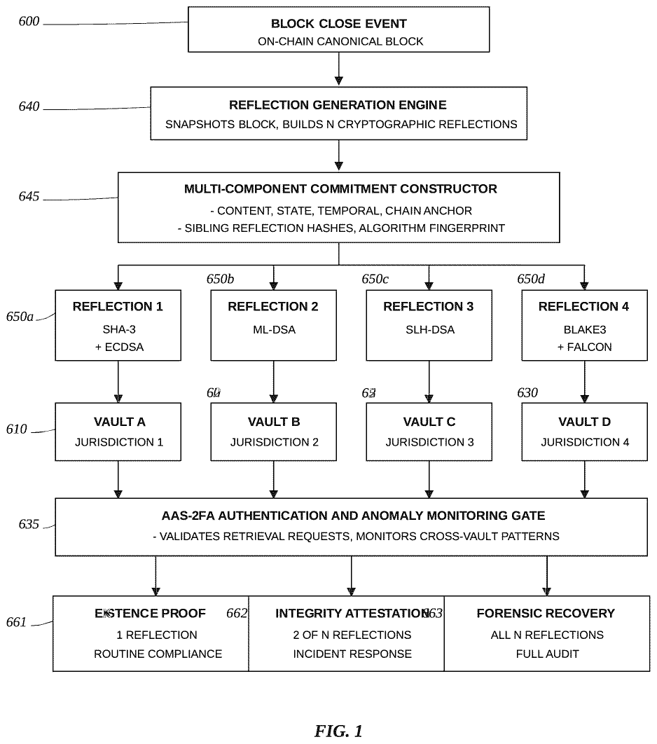

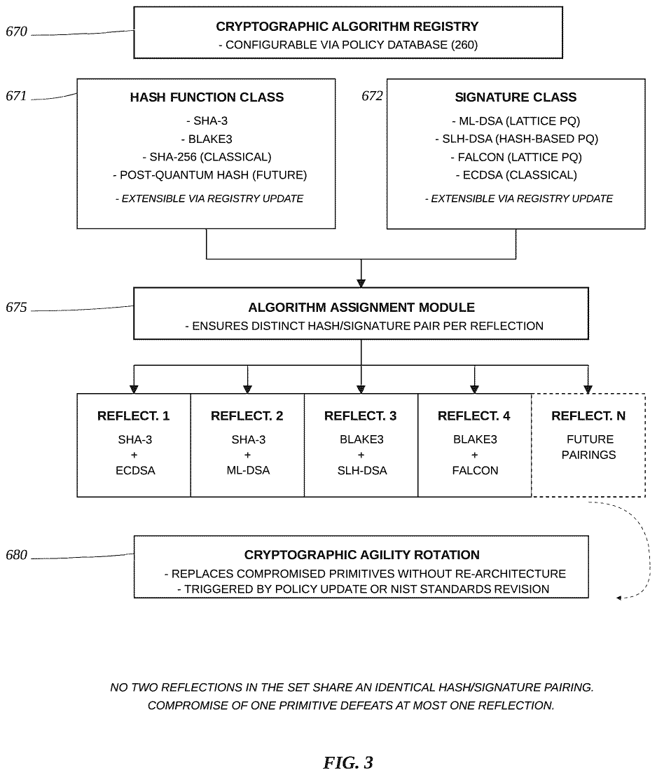

FIG. 1 illustrates an operational workflow of the system. Upon a close event of a transaction block on an associated distributed ledger, a source block 600 is snapshotted by a reflection generation engine 640. The reflection generation engine 640 generates a plurality of N cryptographic reflections 650 (illustrated as instances 650a, 650b, 650c, and 650d for an embodiment in which N equals four, and generalized as 650n for an arbitrary N-th instance) of the source block 600. Each cryptographic reflection 650 is constructed from the source block 600 by a multi-component commitment constructor 645 and is assigned a distinct combination of cryptographic primitives by an algorithm assignment module 675 drawing from a cryptographic algorithm registry 670. In the embodiment depicted in FIG. 1, the reflections are assigned primitives such that reflection 650a is constructed using SHA-3 as the hash function and ECDSA as the digital signature algorithm, reflection 650b is constructed using an ML-DSA digital signature algorithm, reflection 650c is constructed using an SLH-DSA digital signature algorithm, and reflection 650d is constructed using BLAKE3 as the hash function and Falcon as the digital signature algorithm, with the complete hash and signature pairings further depicted in FIG. 3.

Each of the N cryptographic reflections 650 is transmitted to a corresponding vault in a plurality of N vaults comprising Vault A 610, Vault B 620, Vault C 625, and Vault D 630, each operating under a custody arrangement and a jurisdictional regime distinct from each other vault. Retrieval requests directed to the plurality of vaults are validated by an AAS-2FA authentication and anomaly monitoring gate 635. Validated retrieval requests are passed to a three-tier verification module 660, which selects among an existence proof mode 661, an integrity attestation mode 662, and a forensic recovery mode 663 depending on the verification scope requested. As indicated in FIG. 1, the existence proof mode 661 is applicable to routine compliance retrievals, the integrity attestation mode 662 is applicable to incident response retrievals, and the forensic recovery mode 663 is applicable to full audit retrievals.

The reflection generation engine 640 detects block close events through a subscription mechanism appropriate to the associated distributed ledger, including a newHeads subscription on Ethereum-compatible chains, a chaincode event subscription on Hyperledger Fabric, a subnet block notification on Avalanche subnet chains, or equivalent block-finalization notifications on other distributed-ledger platforms. Upon receipt of a block close notification, the reflection generation engine 640 retrieves the closed block from a local chain node or a remote RPC endpoint, computes the multi-component commitments of the plurality of N reflections, applies heterogeneous digital signatures to each reflection, and transmits each reflection to its corresponding vault. In typical embodiments, the end-to-end latency from block close event to completion of reflection transmission to all N vaults is under two seconds. Typical per-block compute cost includes cryptographic hash operations executing in microseconds, digital signature operations executing in milliseconds (including lattice-based and hash-based post-quantum signatures executing in under one hundred milliseconds on commodity hardware), and vault write operations of one to four kilobytes per reflection. Typical per-block aggregate storage cost across the plurality of N vaults is four to sixteen kilobytes for a one-megabyte block, representing a two-hundred-fifty-to-one to one-thousand-to-one reduction relative to full-block off-chain replication.

Upon determining the value of N for the closed block, the reflection generation engine 640 invokes the multi-component commitment constructor 645 to assemble a multi-component commitment for each of the N reflections and invokes the algorithm assignment module 675 to assign a distinct combination of cryptographic primitives to each reflection. Each reflection 650 is signed using its assigned digital signature algorithm with a private cryptographic key associated with the system, and is written to its corresponding vault. In some embodiments, the reflection generation engine 640 operates in a persistent listening mode that continuously subscribes to block-finalization notifications. In other embodiments, the reflection generation engine 640 operates on a scheduled polling basis.

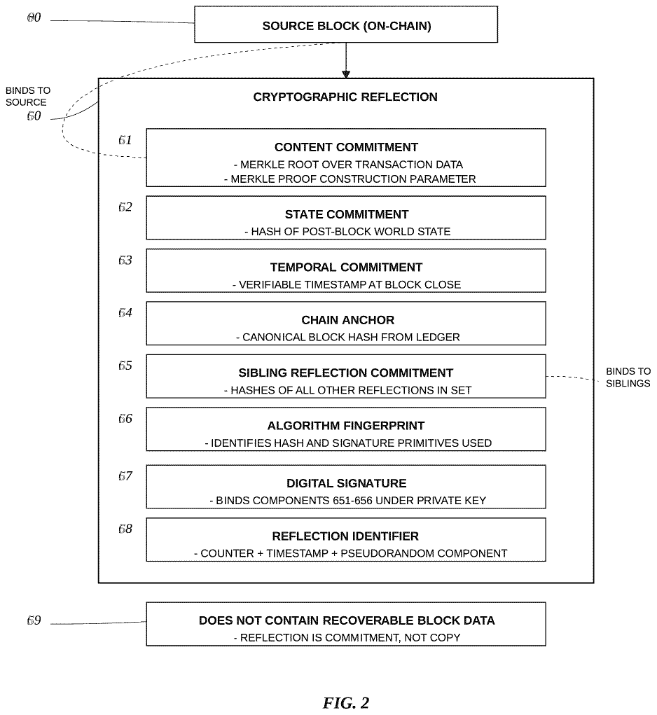

FIG. 2 illustrates the internal structure of a cryptographic reflection 650 as constructed by the multi-component commitment constructor 645. Each cryptographic reflection 650 comprises a content commitment 651, a state commitment 652, a temporal commitment 653, a chain anchor 654, a sibling reflection commitment 655, and a cryptographic algorithm fingerprint 656. The cryptographic reflection 650 further comprises a digital signature 657 binding the commitment components under a private cryptographic key associated with the system, a reflection identifier 658 formed from a sequential counter, a timestamp component, and a cryptographically secure pseudorandom component, and a non-recoverable property assertion 659 indicating that the cryptographic reflection does not contain a recoverable copy of the transaction data of the closed block. As further depicted in FIG. 2, the content commitment 651 binds the cryptographic reflection 650 to the source block 600 from which the cryptographic reflection 650 was generated, and the sibling reflection commitment 655 binds the cryptographic reflection 650 to the other cryptographic reflections in the plurality of N cryptographic reflections generated for the source block 600. The digital signature 657 specifically binds components 651 through 656 under the private cryptographic key, such that modification of any component is detectable through signature verification.

The content commitment 651 comprises a cryptographic digest representing the transaction data of the closed block. In some embodiments, the content commitment 651 is constructed as a Merkle root computed over the transaction data of the closed block, and each cryptographic reflection 650 further comprises a Merkle proof construction parameter sufficient to permit subsequent generation of Merkle proof paths for individual transactions within the closed block. The content commitment 651 does not embed a recoverable copy of the transaction data; rather, the commitment is a fixed-length digest that permits subsequent verification of a separately obtained copy of the transaction data against the commitment.

The state commitment 652 comprises a cryptographic digest representing a post-block state associated with the closed block. In distributed-ledger platforms that maintain an explicit post-block state tree, the state commitment 652 may comprise a state root obtained from the distributed-ledger platform. In distributed-ledger platforms that do not maintain an explicit state tree, the state commitment 652 may comprise a cryptographic digest of a state representation computed by the reflection generation engine 640.

The temporal commitment 653 binds the cryptographic reflection 650 to a verifiable time of generation. In some embodiments, the temporal commitment 653 comprises a timestamp signed by a trusted time-stamping authority, a commitment to a recent block hash of a time-anchoring distributed ledger, or a commitment to a time-beacon output from a public randomness service.

The chain anchor 654 binds the cryptographic reflection 650 to a canonical hash of the closed block on the associated distributed ledger. The chain anchor 654 permits a verifier to confirm that the cryptographic reflection 650 corresponds to the canonical closed block recorded on the distributed ledger.

The sibling reflection commitment 655 binds the cryptographic reflection 650 to the other cryptographic reflections in the plurality of N cryptographic reflections generated for the same closed block. In some embodiments, the sibling reflection commitment 655 comprises a Merkle root computed over the reflection identifiers of the plurality of N cryptographic reflections, permitting each reflection to attest to the existence of its siblings without depending on the integrity of any single sibling.

The cryptographic algorithm fingerprint 656 identifies the cryptographic primitives used to construct the cryptographic reflection 650, including the hash function, the digital signature algorithm, and any auxiliary cryptographic parameters such as curve identifiers or lattice parameters. The cryptographic algorithm fingerprint 656 permits a verifier, upon detecting a cross-reflection validation failure, to identify which cryptographic primitives are implicated in the failure.

FIG. 3 illustrates the cryptographic algorithm registry 670 and the algorithm assignment module 675. The cryptographic algorithm registry 670 comprises at least one classical cryptographic suite and a plurality of post-quantum cryptographic suites. The cryptographic algorithm registry 670 is organized into a hash function class 671 and a digital signature algorithm class 672. As depicted in FIG. 3, the cryptographic algorithm registry 670 is configurable through the policy and rules database 260, permitting an administrator to modify the registry contents and the algorithm assignment policy without modification of the reflection generation engine 640 or of the associated distributed ledger.

In some embodiments, the hash function class 671 comprises a SHA-3 hash function, a BLAKE3 hash function, and a SHA-256 hash function. The digital signature algorithm class 672 comprises a Module-Lattice-based Digital Signature Algorithm (ML-DSA) corresponding to FIPS 204, a Stateless Hash-based Digital Signature Algorithm (SLH-DSA) corresponding to FIPS 205, a Falcon digital signature algorithm, and an elliptic-curve digital signature algorithm (ECDSA).

The algorithm assignment module 675 is configured to assign to each cryptographic reflection 650 a distinct combination of one hash function selected from the hash function class 671 and one digital signature algorithm selected from the digital signature algorithm class 672, such that no two cryptographic reflections in the plurality of N cryptographic reflections are constructed using identical combinations. For an embodiment in which N equals four, four distinct combinations are assigned as depicted in FIG. 3, in which reflection 650a is paired with SHA-3 and ECDSA, reflection 650b is paired with SHA-3 and ML-DSA, reflection 650c is paired with BLAKE3 and SLH-DSA, and reflection 650d is paired with BLAKE3 and Falcon. Because no two reflections in the set share an identical hash and signature pairing, compromise of a single cryptographic primitive defeats at most one reflection in the plurality. The cryptographic algorithm registry 670 is extensible, permitting addition of further hash functions and signature algorithms as standards evolve, and an extensible future pairing slot corresponding to reflection 650n is reserved in the registry to accommodate additional pairings, including pairings built from a post-quantum hash function added to the hash function class 671 through a subsequent registry update.

A cryptographic agility rotation 680 replaces implicated cryptographic primitives in the cryptographic algorithm registry 670 upon detection of a cross-reflection validation failure identifying a specific primitive as compromised. The cryptographic agility rotation 680 does not require modification of the associated distributed ledger; the rotation affects only the algorithm assignments applied to reflections generated subsequent to the rotation. As depicted in FIG. 3, the cryptographic agility rotation 680 may also be triggered by a policy update applied to the policy and rules database 260 or by a revision to a governing cryptographic standard, including a standard published by the U.S. National Institute of Standards and Technology.

The multi-vault distribution architecture comprises a plurality of N vaults including Vault A 610, Vault B 620, Vault C 625, and Vault D 630. Each vault operates under a custody arrangement and a jurisdictional regime distinct from each other vault. In some embodiments, no two vaults in the plurality of N vaults are operated by a single custodian, no two vaults are located in a single jurisdiction, and no vault retains direct cryptographic or network access to any other vault.

Each vault is implemented as at least one of a cloud storage service operated by a distinct cloud provider, a custodial storage arrangement operated by a distinct regulated custodian, a sovereign data facility operated under a distinct jurisdictional regime, and a smart contract repository deployed on a distinct distributed ledger. In one non-limiting example embodiment, Vault A 610 is implemented as a cloud storage service operated by a first commercial cloud provider in a first jurisdiction, Vault B 620 is implemented as a custodial storage arrangement operated by a regulated financial-services custodian in a second jurisdiction, Vault C 625 is implemented as a sovereign data facility operated under a third jurisdictional regime, and Vault D 630 is implemented as a smart contract repository deployed on a distinct distributed ledger.

Each vault implements write-once-read-many (WORM) storage or an equivalent tamper-evident storage mechanism that enforces immutability of cryptographic reflections written to the vault. Inter-vault isolation is enforced by separation of cryptographic key material, separation of network access controls, and absence of cross-vault administrative accounts, such that compromise of a single vault does not propagate to other vaults.

The AAS-2FA authentication and anomaly monitoring gate 635 is configured to authenticate retrieval requests directed to the plurality of N vaults using at least two authentication factors and to apply anomaly detection logic to retrieval request patterns across the plurality of N vaults. The at least two authentication factors are selected from a knowledge factor (such as a password or passphrase), a possession factor (such as a hardware security token or a cryptographic key on a user device), an inherence factor (such as a biometric identifier), and an environmental factor (such as a verified network origin, a verified device attestation, or a verified geolocation).

The anomaly detection logic monitors retrieval request patterns across the plurality of N vaults to detect adversarial retrieval patterns indicative of a harvest-now-decrypt-later campaign. Adversarial retrieval patterns may include, without limitation, a retrieval request volume exceeding a configured threshold within a rolling time window, a retrieval request pattern targeting reflections corresponding to a contiguous range of transaction blocks, a retrieval request pattern originating from a plurality of requestors that share a common network-level identifier, and a retrieval request pattern directed to a plurality of vaults in a temporally correlated sequence. Upon detection of an adversarial retrieval pattern, the authentication and anomaly monitoring gate 635 generates an anomaly score and, when the anomaly score exceeds a configured threshold, denies the retrieval request and triggers an integrity-failure alert.

The authentication and anomaly monitoring gate 635 records each retrieval request, a requestor identifier, an authentication factor set, an anomaly score, and an authorization outcome in a compliance log database.

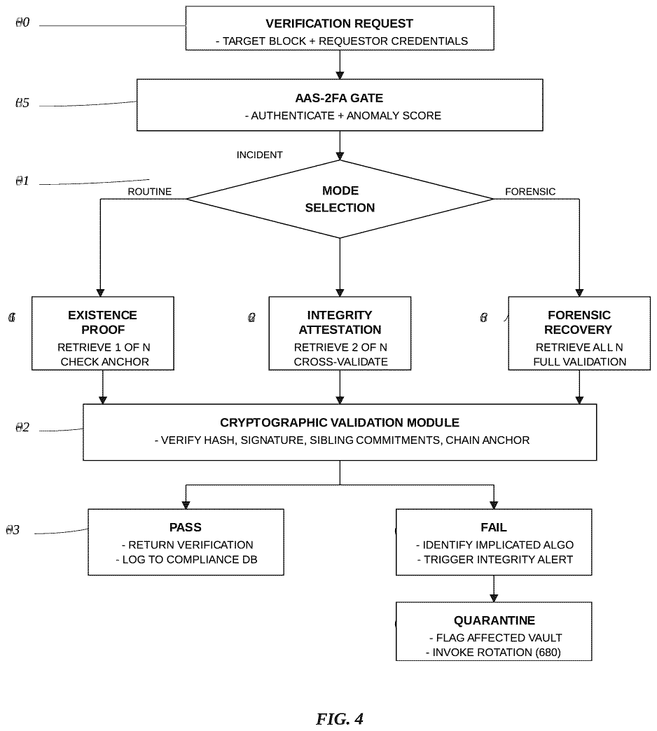

FIG. 4 illustrates the three-tier verification decision flow supported by the three-tier verification module 660. A verification request 690 enters the AAS-2FA authentication and anomaly monitoring gate 635 for authentication and anomaly evaluation. Upon successful authentication, the verification request 690 is passed to a mode selection stage 691 that selects among three verification modes based on the verification scope requested. In the embodiment depicted in FIG. 4, the verification request 690 comprises a target block identifier and requestor credentials, and the mode selection stage 691 routes the verification request 690 along a routine path to the existence proof mode 661, along an incident path to the integrity attestation mode 662, or along a forensic path to the forensic recovery mode 663. A cryptographic validation module 692 performs validation of the hash commitments, the digital signature 657, the sibling reflection commitments 655, and the chain anchor 654 for each retrieved reflection.

In the existence proof mode 661, the three-tier verification module 660 retrieves a single cryptographic reflection from a selected vault in the plurality of N vaults, validates the signature on the retrieved reflection, and validates the chain anchor 654 of the retrieved reflection against the canonical hash of a target transaction block on the associated distributed ledger. A successful existence proof establishes that at least one cryptographic reflection for the target block exists in the multi-vault distribution layer and is bound to the canonical hash of the target block.

In the integrity attestation mode 662, the three-tier verification module 660 retrieves at least two cryptographic reflections from at least two distinct vaults in the plurality of N vaults and cross-validates the multi-component commitments of the retrieved reflections. Cross-validation comprises verifying that the content commitments 651 of the retrieved reflections are consistent with a common underlying transaction data set, that the state commitments 652 of the retrieved reflections are consistent with a common post-block state, that the temporal commitments 653 of the retrieved reflections are consistent with a common block close time, and that the chain anchors 654 of the retrieved reflections are consistent with a common canonical block hash. A successful integrity attestation establishes that no single cryptographic primitive compromise has corrupted the attested record.

In the forensic recovery mode 663, the three-tier verification module 660 retrieves all N cryptographic reflections from all N vaults in the plurality of N vaults and performs full cross-validation of the multi-component commitments. A successful forensic recovery establishes the integrity of the target block under the full heterogeneous set of cryptographic primitives in the cryptographic algorithm registry 670.

As depicted in FIG. 4, the cryptographic validation module 692 drives selection among three outcome paths: a pass 693, a fail 694, and a quarantine 695. When the cryptographic validation module 692 successfully validates each component checked for the selected verification mode, the system reports the pass 693 by returning a verification result to the requestor and logging the verification event to the compliance and audit logs database. When the cryptographic validation module 692 detects a validation failure, the system reports the fail 694 by identifying, based on the cryptographic algorithm fingerprints 656 of the retrieved reflections, which cryptographic primitives are implicated in the failure and by triggering an integrity-failure alert. When validation failure affects one or more vaults or affects the retrieved reflections of a target block to a degree sufficient to warrant isolation, the system further reports the quarantine 695 by flagging the affected vault or vaults in the compliance and audit logs database, denying subsequent retrieval requests directed to reflections of the target block pending investigation, and invoking the cryptographic agility rotation 680 to replace the implicated cryptographic primitives in the cryptographic algorithm registry 670 for reflections generated subsequent to the rotation.

The reflection generation engine 640 may incorporate a risk-based reflection generation policy module that determines, for each closed block, a reflection metadata retention profile and optionally a per-block value of N. The risk-based reflection generation policy module evaluates transactions within the closed block against a defined set of rules or machine learning models to assign a risk classification tag. Risk levels may be categorized as high, medium, or low based on parameters such as transaction value, transaction volume, originating or receiving address reputation, transaction velocity within a rolling time window, and address watchlist membership status.

The risk-based reflection generation policy module may apply multiple risk factors simultaneously, producing a composite risk score that is then mapped to a discrete classification level. For instance, a transaction involving a flagged address and an unusually high transfer amount may receive a composite score that maps to a high risk classification, while a routine transfer between two established and reputable addresses may receive a low risk classification.

For closed blocks containing transactions assigned a higher classification tag, the content commitment 651 may be constructed from a broader set of transaction metadata fields, and the value of N may be set to a higher value, resulting in a greater number of cryptographic reflections distributed across a greater number of vaults. For closed blocks containing only transactions assigned a lower classification tag, the content commitment 651 may be constructed from a narrower set of transaction metadata fields, and the value of N may be set to a lower value consistent with minimum redundancy requirements.

The risk-based reflection generation policy module may access a policy and rules database storing mappings between risk levels, metadata retention profiles, and per-block values of N. The policy and rules database may maintain multiple policy configurations simultaneously, allowing administrators to define separate reflection generation policies for different token types, different distributed-ledger networks, or different regulatory jurisdictions.

The risk-based reflection generation policy module may dynamically update its decision-making criteria based on input from an artificial intelligence anomaly detection module trained on transaction patterns. The artificial intelligence anomaly detection module may be implemented as a machine learning model, such as a neural network, a gradient-boosted decision tree, or an ensemble classifier, trained on historical transaction data to identify patterns indicative of fraud, money laundering, or other suspicious activity, and may maintain its model parameters and risk scores in an artificial intelligence anomaly detection database. When the system is configured to incorporate artificial intelligence-based classification, the risk-based reflection generation policy module may receive real-time risk scoring feedback that influences metadata retention profile selection, per-block N selection, and vault assignment decisions.

In some embodiments, the risk-based reflection generation policy module supports the use of smart contracts to dynamically adjust policy parameters. Smart contracts may be deployed on the associated distributed ledger and may automatically publish updated policy parameters upon predefined triggering conditions, including changes in market conditions, new regulatory requirements published by a governing authority, or user-defined triggers configured by system administrators.

The risk-based reflection generation policy module may optionally cause the reflection generation engine 640 to apply selective compression to transaction metadata fields prior to inclusion in the content commitment 651, such that reflections generated for blocks containing transactions assigned a higher classification tag retain a greater quantity of transaction metadata fields than reflections generated for blocks containing only transactions assigned a lower classification tag. The selective compression may employ a plurality of compression algorithms, including a Lempel-Ziv-Markov chain Algorithm and a GNU zip algorithm, selected based on at least one of transaction volume, the assigned risk classification, and a transaction size threshold defined in the policy and rules database.

The system records compliance data in a compliance and audit logs database. For each retrieval request, the system records a requestor identifier, an authentication factor set, an anomaly score, a selected verification mode, a cross-validation outcome, and an authorization outcome. For each cryptographic-primitive-failure detection, the system records the implicated cryptographic primitives, the cryptographic algorithm fingerprints of the retrieved reflections, the identifier of the affected target block, and the action taken (including quarantine 695 and cryptographic agility rotation 680). For each administrative action, the system records the identity of the administrator, the previous and updated configuration parameters, and the timestamp of the action.

A display module is configured to present system metrics and compliance data to authorized users through a graphical user interface. The display module may present reflection counts by cryptographic algorithm combination, retrieval volumes by verification mode, integrity-failure event histories, anomaly score distributions, vault utilization metrics, and aggregated compliance metrics. The display module may support role-based views, presenting different dashboards and data access levels depending on the role of the authenticated user. For example, a system administrator may have access to a comprehensive dashboard showing all system metrics, policy configurations, and error logs, while a compliance auditor may have access to a more focused view showing verification statuses, retrieval histories, and compliance report generation tools, and an external regulator may have access to a read-only view limited to verified target-block data and completed compliance reports.

The display module may support configurable alerts, allowing administrators to define threshold-based notifications, such as an alert triggered when the anomaly score for a retrieval request exceeds a predefined threshold, or when the number of cryptographic-primitive-failure detections within a rolling time window exceeds a predefined count. The display module may also support the generation and export of formatted compliance reports suitable for submission to regulatory bodies, including reports formatted according to the requirements of specific regulatory frameworks, in formats including PDF, CSV, and XML.

The system may support automated scheduled report generation, where the display module generates and distributes compliance reports at predefined intervals, such as daily, weekly, or monthly, and delivers them to designated recipients via email, secure file transfer, or integration with an external compliance management platform. The compliance and audit logs database may maintain precomputed aggregations such as daily, weekly, and monthly summaries of reflection generation volumes, retrieval volumes by verification mode, and integrity-failure event counts, enabling the display module to render dashboards and generate reports with minimal query latency, even when the underlying data spans millions of reflections accumulated over months or years of operation.

FIG. 1 illustrates the operational workflow of the system. Upon detection by the reflection generation engine 640 of a close event of a transaction block on the associated distributed ledger, the system snapshots the closed source block 600 and, when the risk-based reflection generation policy module is configured, evaluates the transactions of the closed block to determine a reflection metadata retention profile and a per-block value of N.

The multi-component commitment constructor 645 assembles, for each of the N cryptographic reflections 650, a content commitment 651, a state commitment 652, a temporal commitment 653, a chain anchor 654, a sibling reflection commitment 655, and a cryptographic algorithm fingerprint 656. The algorithm assignment module 675 assigns to each cryptographic reflection 650 a distinct combination of one hash function and one digital signature algorithm drawn from the cryptographic algorithm registry 670.

The reflection generation engine 640 applies the assigned digital signature algorithm to each cryptographic reflection 650 to generate the digital signature 657, appends the reflection identifier 658 and the non-recoverable property assertion 659, and transmits each cryptographic reflection 650 to its corresponding vault in the plurality of vaults comprising Vault A 610, Vault B 620, Vault C 625, and Vault D 630.

Upon receipt of a retrieval request directed to one or more of the vaults, the AAS-2FA authentication and anomaly monitoring gate 635 authenticates the retrieval request using at least two authentication factors and applies anomaly detection logic to the retrieval request pattern. Authenticated retrieval requests with acceptable anomaly scores are passed to the three-tier verification module 660, which selects among existence proof mode 661, integrity attestation mode 662, and forensic recovery mode 663 based on the requested verification scope.

The selected verification mode retrieves the corresponding cryptographic reflections from the vaults, performs cross-validation of the multi-component commitments, and reports a pass outcome 693 or a fail outcome 694. Upon a fail outcome 694, the system generates a cryptographic-primitive-failure report, invokes quarantine 695 of the target block, and invokes cryptographic agility rotation 680 to replace the implicated cryptographic primitives in the cryptographic algorithm registry 670 without modification of the associated distributed ledger.

The system records all retrieval events, authentication outcomes, anomaly scores, cross-validation outcomes, and cryptographic-primitive-failure detections in the compliance and audit logs database, and presents aggregated metrics and compliance reports to authorized users through the display module.

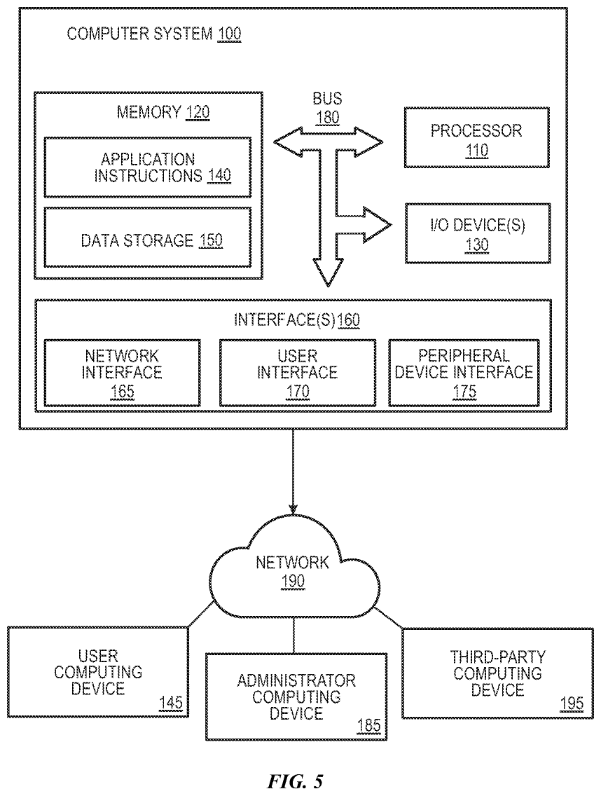

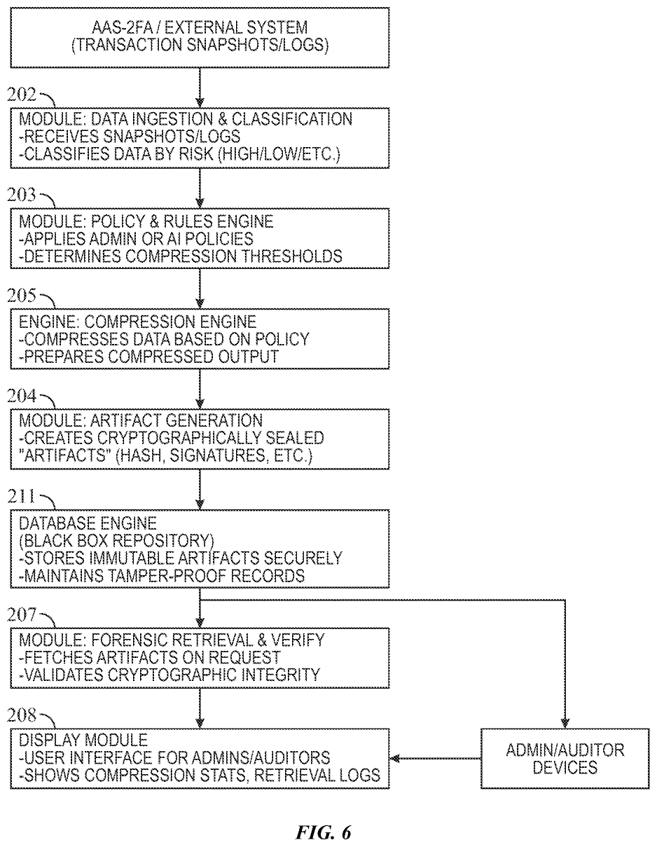

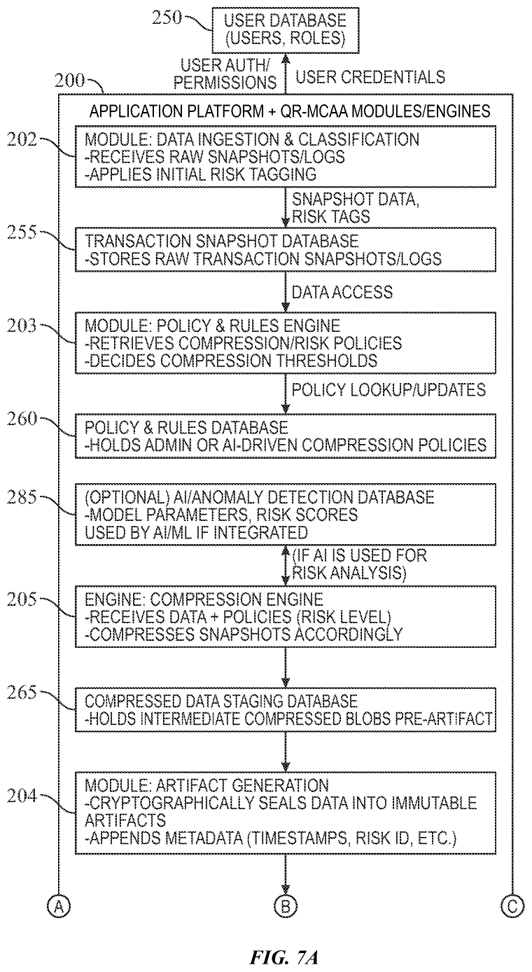

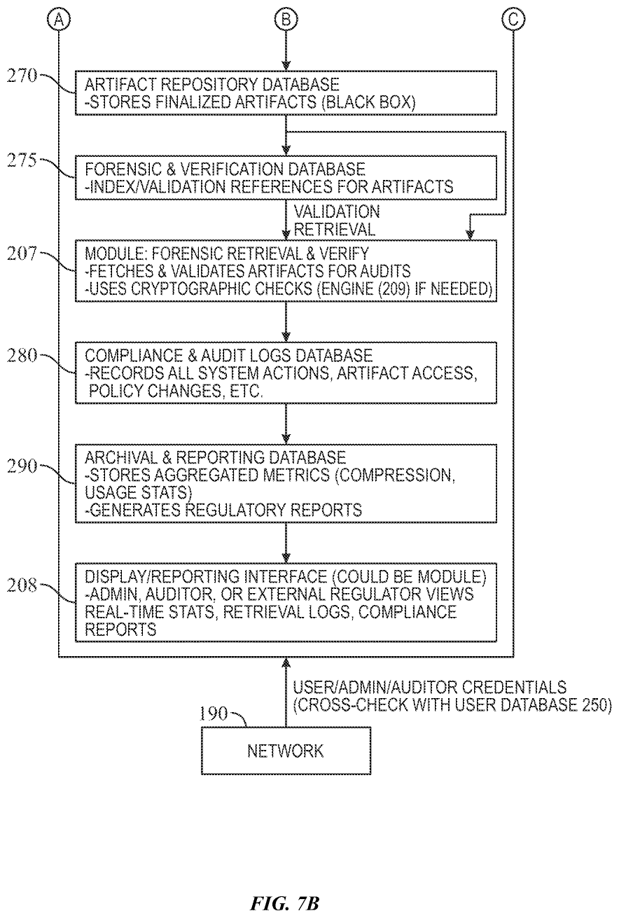

FIG. 5 illustrates a representative computer system 100 suitable for implementing one or more components of the system, including the reflection generation engine 640, the multi-component commitment constructor 645, the algorithm assignment module 675, the AAS-2FA authentication and anomaly monitoring gate 635, the three-tier verification module 660, and the modules and databases depicted in FIGS. 6, 7A, and 7B. The computer system 100 comprises a processor 110, a memory 120, one or more input/output devices 130, and one or more interfaces 160, the foregoing components being communicatively coupled to one another over a bus 180.

The processor 110 may be implemented as a general-purpose central processing unit, a multi-core central processing unit, a graphics processing unit, a tensor processing unit, a field-programmable gate array, an application-specific integrated circuit, or any combination of the foregoing. The processor 110 executes application instructions 140 stored in the memory 120 to perform the functions described herein, including detection of block close events on an associated distributed ledger, generation of cryptographic reflections 650, multi-vault distribution, multi-factor authentication and anomaly monitoring, and tiered cryptographic verification. The processor 110 may execute cryptographic primitives drawn from the cryptographic algorithm registry 670, including hash functions and digital signature algorithms, in software, in hardware-accelerated form using cryptographic instruction-set extensions, or in dedicated cryptographic co-processors accessible over the bus 180.

The memory 120 comprises a non-transitory computer-readable storage medium and stores application instructions 140 that, when executed by the processor 110, cause the computer system 100 to perform the functions described herein, and further stores data storage 150 that holds working data including transaction snapshots, intermediate commitment values, cryptographic algorithm fingerprints 656, and reflection identifiers 658. The memory 120 may comprise volatile memory including random-access memory, non-volatile memory including read-only memory, flash memory, solid-state storage, magnetic storage, optical storage, or any combination of the foregoing.

The input/output devices 130 may comprise a keyboard, a pointing device, a touchscreen, a microphone, a camera, a hardware security module, a hardware token reader, a biometric input device, a display, an indicator light, an audio output device, or any combination of the foregoing. The hardware security module and the hardware token reader, when present, may participate in the multi-factor authentication performed by the AAS-2FA authentication and anomaly monitoring gate 635, including by furnishing a possession factor or an inherence factor to the gate.

The interfaces 160 comprise a network interface 165, a user interface 170, and a peripheral device interface 175. The network interface 165 communicatively couples the computer system 100 to a network 190 and may be implemented over wired Ethernet, fiber optic, cellular, satellite, or wireless local-area network technologies. The user interface 170 supports interactive presentation of system metrics and compliance data through the display module described herein, including reflection counts by cryptographic algorithm combination, retrieval volumes by verification mode, integrity-failure event histories, anomaly score distributions, and aggregated compliance metrics. The peripheral device interface 175 supports connection of cryptographic peripherals including hardware security modules and hardware token readers used by the AAS-2FA authentication and anomaly monitoring gate 635.

The computer system 100 communicates over the network 190 with a user computing device 145, an administrator computing device 185, and a third-party computing device 195. The user computing device 145 originates retrieval requests directed to the plurality of N vaults, the administrator computing device 185 administers configurations of the cryptographic algorithm registry 670, the policy and rules database 260, and the reflection-count policy, and the third-party computing device 195 represents an external regulator, an external auditor, an oracle, a time-stamping authority, or a smart contract repository deployed on a distinct distributed ledger participating as one of the plurality of N vaults. The network 190 may comprise the Internet, a private wide-area network, a virtual private network, a permissioned distributed-ledger overlay network, or any combination of the foregoing, and may interconnect the computer system 100 with the plurality of N vaults comprising Vault A 610, Vault B 620, Vault C 625, and Vault D 630.

The components of the computer system 100 may be co-located in a single physical enclosure, distributed across a plurality of physical enclosures within a single data center, or distributed across a plurality of data centers in distinct geographic and jurisdictional regions. Where the components are distributed, the bus 180 represents a logical communication fabric that may comprise local hardware buses, intra-data-center networks, inter-data-center networks, or any combination of the foregoing.

FIG. 6 illustrates a high-level processing pipeline of the system. An external system supplies transaction snapshots and logs to the system, the external system being protected by the AAS-2FA authentication and anomaly monitoring gate 635 such that snapshots and logs admitted to the pipeline are sourced from authenticated origins. The transaction snapshots and logs include closed-block snapshots produced upon detection of block close events on the associated distributed ledger by the reflection generation engine 640.

The data ingestion and classification module 202 receives the transaction snapshots and logs and classifies the data by risk. In some embodiments, the data ingestion and classification module 202 applies an initial risk classification selected from a high classification, a medium classification, and a low classification, the classification being based on at least one of transaction value, transaction velocity, originating or receiving address watchlist membership, and jurisdictional sensitivity, consistent with the classification criteria used by the risk-based reflection generation policy module described herein.

The policy and rules engine 203 applies administrator-defined or artificial-intelligence-derived policies and determines compression thresholds. In QR-MCAA-extended embodiments, the policy and rules engine 203 further determines, on a per-block basis, the value of N and the metadata retention profile to be applied by the multi-component commitment constructor 645, in accordance with the reflection-count policy and the reflection metadata retention profile described herein. The policy and rules engine 203 applies policies retrieved from the policy and rules database 260 of FIG. 7A and, in embodiments incorporating an artificial-intelligence component, retrieves risk scores from the artificial-intelligence anomaly detection database 285 of FIG. 7A.

The compression engine 205 compresses the data based on the applied policy and prepares a compressed output. The compression engine 205 may apply a plurality of compression algorithms including a Lempel-Ziv-Markov chain Algorithm and a GNU zip algorithm, selected based on at least one of the assigned risk classification, transaction volume, and a transaction size threshold defined in the policy and rules database 260. In QR-MCAA-extended embodiments, the compression engine 205 cooperates with the multi-component commitment constructor 645 such that selectively compressed transaction metadata is incorporated into the content commitment 651 of each cryptographic reflection 650 in accordance with the reflection metadata retention profile.

The artifact generation module 204 creates cryptographically sealed artifacts. As used herein in connection with the QR-MCAA extension, the artifacts produced by the artifact generation module 204 comprise the cryptographic reflections 650 described in connection with FIGS. 1 and 2, each cryptographic reflection 650 comprising a multi-component commitment including the content commitment 651, the state commitment 652, the temporal commitment 653, the chain anchor 654, the sibling reflection commitment 655, and the cryptographic algorithm fingerprint 656, together with the digital signature 657, the reflection identifier 658, and the non-recoverable property assertion 659. The cryptographic seal applied by the artifact generation module 204 is constructed using the cryptographic primitives assigned to the cryptographic reflection 650 by the algorithm assignment module 675 drawing from the cryptographic algorithm registry 670.

The database engine 211 implements a black-box repository that stores the immutable artifacts securely and maintains tamper-proof records. In QR-MCAA-extended embodiments, the black-box repository is implemented in a distributed manner across the plurality of N vaults comprising Vault A 610, Vault B 620, Vault C 625, and Vault D 630, each vault operating under a custody arrangement and a jurisdictional regime distinct from each other vault as described in connection with FIG. 1, such that no single instance of the database engine 211 holds more than one cryptographic reflection 650 of any given source block 600.

The forensic retrieval and verification module 207 fetches artifacts on request and validates their cryptographic integrity. In QR-MCAA-extended embodiments, the forensic retrieval and verification module 207 implements the three-tier verification module 660 of FIG. 1, executing one of the existence proof mode 661, the integrity attestation mode 662, and the forensic recovery mode 663 in dependence on the verification scope of the request, and performing cryptographic verification of the multi-component commitment of each retrieved cryptographic reflection 650 including verification of the digital signature 657, cross-validation of the content commitment 651, the state commitment 652, the temporal commitment 653, and the chain anchor 654, and confirmation of the sibling reflection commitment 655 against the reflection identifiers 658 of the retrieved cryptographic reflections 650.

The display module 208 provides a user interface for administrators and auditors and presents compression statistics and retrieval logs to admin and auditor devices. In QR-MCAA-extended embodiments, the display module 208 further presents reflection counts by cryptographic algorithm combination, retrieval volumes by verification mode, integrity-failure event histories, anomaly score distributions, and vault utilization metrics, and supports role-based views for administrators, compliance auditors, and external regulators as described herein.

FIGS. 7A and 7B together illustrate an application platform 200 incorporating QR-MCAA modules and engines and a complete end-to-end data flow comprising an upstream portion shown in FIG. 7A and a downstream portion shown in FIG. 7B, the two portions being interconnected by off-page connectors A, B, and C. The reference numerals introduced in FIG. 6 are retained in FIGS. 7A and 7B for the corresponding modules and engines, and additional reference numerals are introduced in FIGS. 7A and 7B for databases supporting the application platform 200.

The user database 250 holds users and roles and exchanges user authentication, permissions, and credentials with the application platform 200. The user database 250 maintains the role definitions used by the role-based views supported by the display module 208, including a system administrator role with access to a comprehensive dashboard showing system metrics, policy configurations, and error logs, a compliance auditor role with access to verification statuses, retrieval histories, and compliance report generation tools, and an external regulator role with read-only access limited to verified target-block data and completed compliance reports. The user database 250 cooperates with the AAS-2FA authentication and anomaly monitoring gate 635 in validating retrieval requests and administrator actions, including by supplying knowledge factors and possession factor references to the gate.

The data ingestion and classification module 202 of FIG. 7A applies initial risk tagging to received snapshots and logs and outputs snapshot data and risk tags to the transaction snapshot database 255, the transaction snapshot database 255 storing the raw transaction snapshots and logs prior to compression. The transaction snapshot database 255 supports subsequent retrieval of the raw transaction snapshots by downstream modules, including by the policy and rules engine 203 to inform compression and reflection-policy decisions and by the multi-component commitment constructor 645 in computing the content commitment 651, the state commitment 652, and the chain anchor 654 of each cryptographic reflection 650.

The policy and rules engine 203 retrieves compression and risk policies from the policy and rules database 260 by way of policy lookups and updates and decides compression thresholds. The policy and rules database 260 holds administrator-defined or artificial-intelligence-driven compression policies, the reflection-count policy that determines the per-block value of N, the reflection metadata retention profile, and the configuration of the cryptographic algorithm registry 670. As described in connection with FIG. 3, the policy and rules database 260 is the configuration source through which an administrator may modify the cryptographic algorithm registry 670 and the algorithm assignment policy without modification of the reflection generation engine 640 or of the associated distributed ledger, and through which a cryptographic agility rotation 680 may be invoked.

The artificial-intelligence anomaly detection database 285 is provided as an optional component and holds model parameters and risk scores used by an artificial-intelligence or machine-learning component if integrated for risk analysis. The artificial-intelligence anomaly detection database 285 may store model parameters of a neural network, a gradient-boosted decision tree, or an ensemble classifier trained on historical transaction data to identify patterns indicative of fraud, money laundering, or other suspicious activity, and may store real-time risk scores supplied to the risk-based reflection generation policy module to influence metadata retention profile selection, per-block N selection, and vault assignment decisions.

The compression engine 205 of FIG. 7A receives data and policies including a risk level from the policy and rules engine 203 and compresses the snapshots accordingly, and outputs intermediate compressed blobs to the compressed data staging database 265. The compressed data staging database 265 holds the intermediate compressed blobs prior to artifact generation and supports validation of compression success or failure prior to invocation of the artifact generation module 204.

The artifact generation module 204 of FIG. 7A cryptographically seals data into immutable artifacts and appends metadata including timestamps and risk identifiers. In QR-MCAA-extended embodiments, the artifact generation module 204 generates the plurality of N cryptographic reflections 650 of the source block 600, each cryptographic reflection 650 comprising the multi-component commitment described in connection with FIG. 2, the digital signature 657 generated using the cryptographic primitives assigned to the cryptographic reflection 650 by the algorithm assignment module 675, the reflection identifier 658, and the non-recoverable property assertion 659, the appended metadata further including the temporal commitment 653 and the cryptographic algorithm fingerprint 656.

Off-page connectors A, B, and C continue the flow of FIG. 7A into FIG. 7B. Connectors A, B, and C represent the transmission of the cryptographically sealed artifacts and associated metadata from the artifact generation module 204 to downstream storage and verification modules and databases of FIG. 7B for finalization, indexing, and audit access.

Referring to FIG. 7B, the artifact repository database 270 stores the finalized artifacts as a black-box repository. In QR-MCAA-extended embodiments, the artifact repository database 270 is implemented in a distributed manner across the plurality of N vaults comprising Vault A 610, Vault B 620, Vault C 625, and Vault D 630, the artifact repository database 270 corresponding to a logical aggregation of the per-vault storage of the cryptographic reflections 650, with each cryptographic reflection 650 in the plurality being stored in a single corresponding vault and no single vault storing more than one cryptographic reflection 650 of any given source block 600.

The forensic and verification database 275 holds index and validation references for the artifacts and supplies validation retrieval to the forensic retrieval and verification module 207. In QR-MCAA-extended embodiments, the forensic and verification database 275 indexes the cryptographic reflections 650 by source block 600, by reflection identifier 658, and by cryptographic algorithm fingerprint 656, and stores validation references including expected multi-component commitment values, expected sibling reflection commitments 655, and chain anchors 654 obtained from the associated distributed ledger, the validation references being used by the forensic retrieval and verification module 207 to perform the cross-validation of multi-component commitments described in connection with the integrity attestation mode 662 and the forensic recovery mode 663.

The forensic retrieval and verification module 207 fetches and validates artifacts for audits and uses cryptographic checks performed by an engine 209 when needed. In QR-MCAA-extended embodiments, the engine 209 performs the cryptographic operations underlying the three-tier verification module 660, including verification of the digital signature 657 of each retrieved cryptographic reflection 650 under the cryptographic primitives identified by the cryptographic algorithm fingerprint 656, recomputation of expected values for the content commitment 651, the state commitment 652, the temporal commitment 653, and the chain anchor 654, and validation of the sibling reflection commitment 655 against the reflection identifiers 658 of the retrieved cryptographic reflections 650. Upon detection of a cross-reflection validation failure, the engine 209 cooperates with the cryptographic agility rotation 680 to identify the implicated cryptographic primitive and to invoke replacement of the implicated cryptographic primitive in the cryptographic algorithm registry 670 without modification of the associated distributed ledger.

The compliance and audit logs database 280 records system actions, artifact accesses, and policy changes. The records maintained by the compliance and audit logs database 280 include, for each retrieval request, a requestor identifier, an authentication factor set, an anomaly score, a selected verification mode from among the existence proof mode 661, the integrity attestation mode 662, and the forensic recovery mode 663, a cross-validation outcome, and an authorization outcome, and further include, for each cryptographic-primitive-failure detection, the implicated cryptographic primitive, the cryptographic algorithm fingerprints 656 of the retrieved cryptographic reflections 650, the identifier of the affected target block, and the action taken including quarantine 695 and cryptographic agility rotation 680.

The archival and reporting database 290 stores aggregated metrics including compression and usage statistics and generates regulatory reports. The aggregated metrics may include reflection counts by cryptographic algorithm combination, retrieval volumes by verification mode, integrity-failure event histories, anomaly score distributions, vault utilization metrics, and storage cost metrics, the aggregated metrics being maintained as precomputed daily, weekly, and monthly summaries to enable rendering of dashboards and generation of reports with low query latency even when the underlying data spans millions of cryptographic reflections accumulated over months or years of operation. The archival and reporting database 290 supports generation and export of formatted compliance reports suitable for submission to regulatory bodies in formats including PDF, CSV, and XML.

The display and reporting interface 208 of FIG. 7B presents real-time statistics, retrieval logs, and compliance reports to administrators, auditors, and external regulators. The display and reporting interface 208 communicates over the network 190 and exchanges user, administrator, and auditor credentials with the application platform 200, the credentials being cross-checked against the user database 250 by the AAS-2FA authentication and anomaly monitoring gate 635 prior to grant of access. The display and reporting interface 208 supports the role-based views and configurable alerts described herein, including alerts triggered when the anomaly score for a retrieval request exceeds a predefined threshold and alerts triggered when the count of cryptographic-primitive-failure detections within a rolling time window exceeds a predefined count.

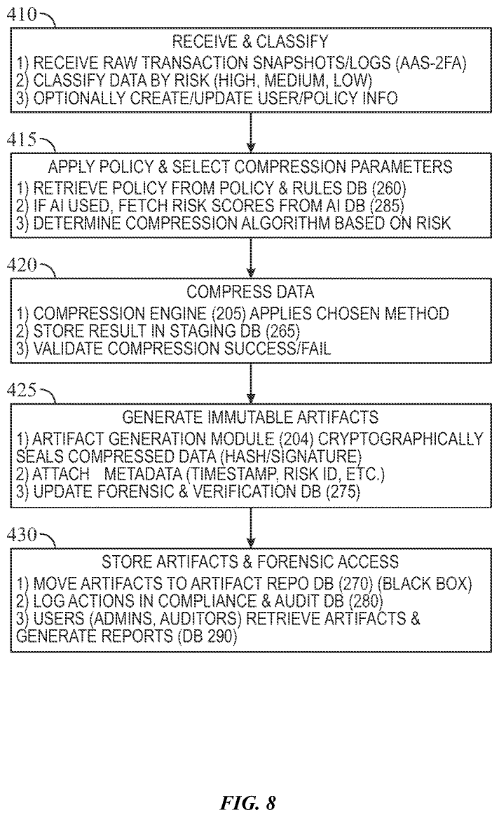

FIG. 8 illustrates a method performed by the system. The method comprises a receive-and-classify step 410, an apply-policy-and-select-compression-parameters step 415, a compress-data step 420, a generate-immutable-artifacts step 425, and a store-artifacts-and-forensic-access step 430. The steps are described in sequence below; in some embodiments, the steps may be executed concurrently or substantially concurrently, or in a different order, in accordance with the functionality involved and as described in connection with FIGS. 1 through 7B.

At the receive-and-classify step 410, the system receives raw transaction snapshots and logs from a source protected by the AAS-2FA authentication and anomaly monitoring gate 635, classifies the data by risk into a high risk classification, a medium risk classification, and a low risk classification, and optionally creates or updates user information and policy information in the user database 250 and the policy and rules database 260 respectively. In QR-MCAA-extended embodiments, the receive-and-classify step 410 corresponds to detection by the reflection generation engine 640 of a close event of a transaction block on the associated distributed ledger and snapshotting of the closed source block 600, the assigned risk classification informing both the per-block value of N and the reflection metadata retention profile applied to the source block 600.

At the apply-policy-and-select-compression-parameters step 415, the system retrieves a policy from the policy and rules database 260, optionally fetches risk scores from the artificial-intelligence anomaly detection database 285 if an artificial-intelligence component is used for risk analysis, and determines a compression algorithm based on the assigned risk. In QR-MCAA-extended embodiments, the apply-policy-and-select-compression-parameters step 415 further determines the per-block value of N from the reflection-count policy stored in the policy and rules database 260, the reflection metadata retention profile to be applied by the multi-component commitment constructor 645, and the cryptographic-primitive assignments to be applied to the plurality of N cryptographic reflections 650 by the algorithm assignment module 675 drawing from the cryptographic algorithm registry 670.

At the compress-data step 420, the compression engine 205 applies the chosen compression method, stores the result in the compressed data staging database 265, and validates the compression success or failure. In QR-MCAA-extended embodiments, the compressed result of the compress-data step 420 is consumed by the multi-component commitment constructor 645 in computing the content commitment 651 of each cryptographic reflection 650 in accordance with the reflection metadata retention profile, such that cryptographic reflections 650 generated for source blocks 600 containing transactions assigned a higher classification tag retain a greater quantity of transaction metadata fields than cryptographic reflections 650 generated for source blocks 600 containing only transactions assigned a lower classification tag.

At the generate-immutable-artifacts step 425, the artifact generation module 204 cryptographically seals the compressed data with a hash and a digital signature, attaches metadata including a timestamp and a risk identifier, and updates the forensic and verification database 275. In QR-MCAA-extended embodiments, the generate-immutable-artifacts step 425 corresponds to generation by the multi-component commitment constructor 645 of the multi-component commitment of each cryptographic reflection 650, including the content commitment 651, the state commitment 652, the temporal commitment 653, the chain anchor 654, the sibling reflection commitment 655, and the cryptographic algorithm fingerprint 656, application of the digital signature 657 binding components 651 through 656 under the assigned digital signature algorithm and a private cryptographic key, appending of the reflection identifier 658 and the non-recoverable property assertion 659, and indexing of the resulting cryptographic reflection 650 in the forensic and verification database 275 by source block 600, by reflection identifier 658, and by cryptographic algorithm fingerprint 656.

At the store-artifacts-and-forensic-access step 430, the system moves the artifacts to the artifact repository database 270 implementing the black-box repository, logs system actions in the compliance and audit logs database 280, and permits users including administrators and auditors to retrieve artifacts and to generate reports from the archival and reporting database 290. In QR-MCAA-extended embodiments, the move of the artifacts to the artifact repository database 270 is implemented as transmission of each of the plurality of N cryptographic reflections 650 to a corresponding vault in the plurality of N vaults comprising Vault A 610, Vault B 620, Vault C 625, and Vault D 630, each vault operating under a custody arrangement and a jurisdictional regime distinct from each other vault, and the retrieval of artifacts and generation of reports is gated by the AAS-2FA authentication and anomaly monitoring gate 635 and is performed by the three-tier verification module 660 in one of the existence proof mode 661, the integrity attestation mode 662, and the forensic recovery mode 663 in dependence on the verification scope of the request.

The method of FIG. 8 may be performed in a persistent listening mode in which the receive-and-classify step 410 is triggered by each block close notification received by the reflection generation engine 640, or in a scheduled polling mode in which the receive-and-classify step 410 is performed at configured intervals against a chain node or remote remote-procedure-call endpoint of the associated distributed ledger. In typical embodiments, the end-to-end latency from receive-and-classify step 410 to completion of the store-artifacts-and-forensic-access step 430 is under two seconds for a one-megabyte source block 600 and a per-block value of N equal to four, and the per-block aggregate storage cost across the plurality of N vaults is four to sixteen kilobytes for the same source block 600.

Various implementations of the invention involve the technical field of quantum-resistant cryptographic protection of distributed-ledger transaction data including detecting close events of transaction blocks on a distributed ledger in real time, generating a plurality of heterogeneously constructed cryptographic reflections bound by multi-component commitments, distributing the reflections to jurisdictionally and custodially separated vaults, authenticating retrieval requests with multi-factor and anomaly-aware gating, and cross-validating the multi-component commitments across heterogeneous cryptographic primitives, and are therefore necessarily rooted in computer technology.

For example, the aforementioned steps are inherently computer-based and cannot be performed in the human mind. The present invention amounts to more than merely implementing the generic computer as a tool to gather, analyze, and output data because the steps of the present method, system, or product improve the field of quantum-resistant cryptographic protection of distributed-ledger transaction data by enabling heterogeneous cryptographic reflection generation, multi-vault jurisdictional distribution, anomaly-aware authentication, and cross-primitive tiered verification, all within a single integrated platform that preserves cryptographic integrity against a quantum-capable adversary without modification of the underlying distributed-ledger consensus mechanism. The steps of the present invention would be impossible to accomplish on pen and paper due to the volume of data, the cryptographic computations involved, and the real-time nature of the operations.

Implementations of the present invention may include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

What is claimed is:

1. A computer-implemented system for quantum-resistant cryptographic protection of distributed-ledger transaction data, the system comprising one or more hardware processors and a non-transitory memory storing instructions that, when executed by the one or more hardware processors, cause the system to instantiate:
a reflection generation engine configured to detect a close event of a transaction block on an associated distributed ledger and to generate, in response to detecting the close event, a plurality of N cryptographic reflections of the transaction block, where N is at least three;
wherein each cryptographic reflection in the plurality of N cryptographic reflections comprises a multi-component commitment to the transaction block, the multi-component commitment comprising (i) a content commitment representing transaction data of the transaction block, (ii) a state commitment representing a post-block state, (iii) a temporal commitment binding the cryptographic reflection to a verifiable time of generation, (iv) a chain anchor binding the cryptographic reflection to a canonical hash of the transaction block on the distributed ledger, (v) a sibling reflection commitment binding the cryptographic reflection to other cryptographic reflections in the plurality of N cryptographic reflections, and (vi) a cryptographic algorithm fingerprint identifying cryptographic primitives used to construct the cryptographic reflection;
wherein each cryptographic reflection is constructed using a distinct combination of cryptographic primitives selected from a cryptographic algorithm registry, such that no two cryptographic reflections are constructed using identical combinations, and wherein the cryptographic algorithm registry comprises at least one classical cryptographic suite and a plurality of post-quantum cryptographic suites;
wherein the cryptographic reflection does not contain a recoverable copy of the transaction data of the transaction block;
a multi-vault distribution layer comprising a plurality of N vaults, wherein the reflection generation engine transmits each cryptographic reflection to a corresponding vault in the plurality of N vaults, and wherein each vault is implemented as at least one of a cloud storage service operated by a distinct cloud provider, a custodial storage arrangement operated by a distinct regulated custodian, a sovereign data facility operated under a distinct jurisdictional regime, and a smart contract repository deployed on a distinct distributed ledger, and wherein each vault operates under a custody arrangement and a jurisdictional regime distinct from each other vault;
an authentication and anomaly monitoring gate configured to authenticate retrieval requests using at least two factors selected from a knowledge factor, a possession factor, an inherence factor, and an environmental factor, and to apply anomaly detection logic to retrieval request patterns across the plurality of N vaults to detect adversarial retrieval patterns; and
a three-tier verification module configured to support (i) an existence proof mode retrieving a single cryptographic reflection and validating its chain anchor against the canonical hash of a target block, (ii) an integrity attestation mode retrieving at least two cryptographic reflections and cross-validating their multi-component commitments, and (iii) a forensic recovery mode retrieving all N cryptographic reflections and performing full cross-validation.

2. The system of claim 1, wherein the cryptographic algorithm registry comprises a SHA-3 hash function, a BLAKE3 hash function, a Module-Lattice-based Digital Signature Algorithm, a Stateless Hash-based Digital Signature Algorithm, a Falcon digital signature algorithm, and an elliptic-curve digital signature algorithm, and wherein each cryptographic reflection is assigned a distinct combination of one hash function and one digital signature algorithm from the registry.

3. The system of claim 1, wherein the content commitment of each cryptographic reflection comprises a Merkle root computed over the transaction data of the transaction block, and wherein each cryptographic reflection further comprises a Merkle proof construction parameter sufficient to permit subsequent generation of Merkle proof paths for individual transactions within the transaction block.

4. The system of claim 1, wherein N is configurable on a per-block basis according to a reflection-count policy stored in a policy database, the reflection-count policy assigning higher values of N to transaction blocks containing transaction records satisfying classification criteria including at least one of transaction value exceeding a configured threshold, transaction velocity exceeding a configured threshold, originating or receiving address watchlist membership, and jurisdictional sensitivity classification.

5. The system of claim 1, wherein the multi-vault distribution layer is structured such that no two vaults in the plurality of N vaults are operated by a single custodian, no two vaults are located in a single jurisdiction, and no vault retains direct cryptographic or network access to any other vault.

6. The system of claim 1, wherein the authentication and anomaly monitoring gate is further configured to record each retrieval request, a requestor identifier, an authentication factor set, an anomaly score, and an authorization outcome in a compliance log database, and to trigger an integrity-failure alert when an anomaly score exceeds a configured threshold or when a multi-component commitment cross-validation fails.

7. The system of claim 1, wherein the three-tier verification module is further configured to detect, during integrity attestation mode or forensic recovery mode, a mismatch between the multi-component commitments of two or more retrieved cryptographic reflections, to identify based on the cryptographic algorithm fingerprints which cryptographic primitives are implicated in the mismatch, and to generate a cryptographic-primitive-failure report, and wherein the system is further configured to invoke a cryptographic agility rotation that replaces the implicated cryptographic primitives in the cryptographic algorithm registry with replacement cryptographic primitives without modification of the associated distributed ledger.

8. The system of claim 1, further comprising a risk-based reflection generation policy module configured to determine, for each transaction block, a reflection metadata retention profile based on a composite score computed from a weighted combination of at least three input parameters selected from transaction value, transaction velocity within a rolling time window, originating address reputation score, receiving address reputation score, jurisdictional origin of transactions, and address watchlist membership status, and wherein the content commitment of each cryptographic reflection is constructed in accordance with the reflection metadata retention profile.

9. A computer-implemented method for quantum-resistant cryptographic protection of distributed-ledger transaction data, the method comprising:
detecting, by a reflection generation engine executed by one or more hardware processors, a close event of a transaction block on an associated distributed ledger;
generating a plurality of N cryptographic reflections of the transaction block, where N is at least three, wherein each cryptographic reflection comprises a multi-component commitment including a content commitment, a state commitment, a temporal commitment, a chain anchor, a sibling reflection commitment, and a cryptographic algorithm fingerprint, and each cryptographic reflection is constructed using a distinct combination of cryptographic primitives from a cryptographic algorithm registry comprising at least one classical cryptographic suite and a plurality of post-quantum cryptographic suites, and wherein the cryptographic reflection does not contain a recoverable copy of the transaction data of the transaction block;
transmitting each cryptographic reflection to a corresponding vault in a plurality of N vaults, wherein each vault is implemented as at least one of a cloud storage service, a custodial storage arrangement, a sovereign data facility, and a smart contract repository, and wherein each vault operates under a custody arrangement and a jurisdictional regime distinct from each other vault;
upon receipt of a retrieval request, authenticating the retrieval request through an authentication and anomaly monitoring gate using at least two factors selected from a knowledge factor, a possession factor, an inherence factor, and an environmental factor, and applying anomaly detection logic to retrieval request patterns across the plurality of N vaults; and
performing cryptographic verification of a target block by executing one of an existence proof mode retrieving one cryptographic reflection, an integrity attestation mode retrieving at least two cryptographic reflections with cross-validation, and a forensic recovery mode retrieving all N cryptographic reflections with full cross-validation.

10. The method of claim 9, wherein the cryptographic algorithm registry comprises at least a SHA-3 hash function, a BLAKE3 hash function, a Module-Lattice-based Digital Signature Algorithm, a Stateless Hash-based Digital Signature Algorithm, a Falcon digital signature algorithm, and an elliptic-curve digital signature algorithm, and wherein each cryptographic reflection is assigned a distinct combination of one hash function and one digital signature algorithm.

11. The method of claim 9, wherein the content commitment is constructed as a Merkle root computed over the transaction data of the transaction block, and wherein each cryptographic reflection further comprises a Merkle proof construction parameter.

12. The method of claim 9, further comprising determining the value of N on a per-block basis according to a reflection-count policy assigning higher values of N to transaction blocks satisfying classification criteria including at least one of transaction value exceeding a configured threshold, transaction velocity exceeding a configured threshold, originating or receiving address watchlist membership, and jurisdictional sensitivity classification.

13. The method of claim 9, further comprising, upon detecting a mismatch between multi-component commitments of retrieved cryptographic reflections, identifying based on the cryptographic algorithm fingerprints which cryptographic primitives are implicated in the mismatch, generating a cryptographic-primitive-failure report, and invoking a cryptographic agility rotation that replaces the implicated cryptographic primitives in the cryptographic algorithm registry.

14. The method of claim 9, further comprising, upon detecting an anomaly score exceeding a configured threshold or a multi-component commitment cross-validation failure, generating an integrity-failure alert comprising a target block identifier, a timestamp of the failure, a requestor identifier, an anomaly score, an identification of implicated cryptographic primitives, and a recommended remediation action.

15. The method of claim 9, further comprising determining a reflection metadata retention profile for each transaction block based on a composite score computed from a weighted combination of at least three input parameters selected from transaction value, transaction velocity, originating address reputation score, receiving address reputation score, jurisdictional origin of transactions, and address watchlist membership status, and constructing the content commitment of each cryptographic reflection in accordance with the reflection metadata retention profile.

16. A non-transitory computer-readable storage medium storing instructions that, when executed by one or more hardware processors of a computing system, cause the computing system to:
detect a close event of a transaction block on an associated distributed ledger;
generate a plurality of N cryptographic reflections of the transaction block, where N is at least three, each cryptographic reflection comprising a multi-component commitment including a content commitment, a state commitment, a temporal commitment, a chain anchor, a sibling reflection commitment, and a cryptographic algorithm fingerprint, and each cryptographic reflection being constructed using a distinct combination of cryptographic primitives from a cryptographic algorithm registry comprising at least one classical cryptographic suite and a plurality of post-quantum cryptographic suites, wherein the cryptographic reflection does not contain a recoverable copy of the transaction data of the transaction block;
transmit each cryptographic reflection to a corresponding vault in a plurality of N vaults, wherein each vault is implemented as at least one of a cloud storage service, a custodial storage arrangement, a sovereign data facility, and a smart contract repository, and wherein each vault operates under a custody arrangement and a jurisdictional regime distinct from each other vault;
authenticate retrieval requests through an authentication gate requiring at least two factors and apply anomaly detection logic to retrieval request patterns across the plurality of N vaults; and
perform cryptographic verification of a target block by executing one of three verification modes comprising an existence proof mode, an integrity attestation mode, and a forensic recovery mode, each mode retrieving and cross-validating a different number of cryptographic reflections.

17. The non-transitory computer-readable storage medium of claim 16, wherein the instructions further cause the computing system to assign to each cryptographic reflection a distinct combination of one hash function and one digital signature algorithm from the cryptographic algorithm registry, the cryptographic algorithm registry comprising at least a SHA-3 hash function, a BLAKE3 hash function, a Module-Lattice-based Digital Signature Algorithm, a Stateless Hash-based Digital Signature Algorithm, a Falcon digital signature algorithm, and an elliptic-curve digital signature algorithm.

18. The non-transitory computer-readable storage medium of claim 16, wherein the instructions further cause the computing system to construct the content commitment as a Merkle root computed over the transaction data of the transaction block and to embed within each cryptographic reflection a Merkle proof construction parameter sufficient to permit subsequent generation of Merkle proof paths for individual transactions.

19. The non-transitory computer-readable storage medium of claim 16, wherein the instructions further cause the computing system to, upon detecting a mismatch between multi-component commitments of retrieved cryptographic reflections, identify based on the cryptographic algorithm fingerprints which cryptographic primitives are implicated in the mismatch, and invoke a cryptographic agility rotation that replaces the implicated cryptographic primitives in the cryptographic algorithm registry without modification of the associated distributed ledger.

20. The non-transitory computer-readable storage medium of claim 16, wherein the instructions further cause the computing system to log retrieval request events, authentication outcomes, anomaly scores, multi-component commitment cross-validation results, and cryptographic-primitive-failure detections in a compliance log database, and to generate aggregated metrics comprising reflection counts by cryptographic algorithm combination, retrieval volumes by verification mode, and integrity-failure event histories accessible through a graphical user interface configurable with role-based views.
